(19) United States
(12) Patent Application Publication
(10) Pub. No.: US 2006/0262039 A1
(43) Pub. Date: Nov. 23, 2006

(54) Driving method for plasma display panel

(75) Inventors: Hirokazu Hashikawa, Chuo-shi (JP); Morikazu Konishi, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/390,159

(22) Filed: Mar. 28, 2006

(30) Foreign Application Priority Data
Mar. 31, 2005 (JP) 2005-100784

(51) Int. Cl. G09G 3/28

(52) U.S. Cl. 345/63

(57) ABSTRACT

A driving method for plasma display panel that allows increasing contrast and reducing power consumption. The pulse voltage of sustain pulses which are applied to discharge cells, supporting a pixel each, in order to cause discharge of the discharge cells and sustain a discharge-induced light-emission state, is modified on the basis of the average brightness level per frame of an input video signal.

### BACKGROUND OF THE INVENTION

1. Field of the Invention

The present invention relates to a driving method for a matrix display-type plasma display panel (hereinafter PDP).

2. Description of the Related Background Art

Various kinds of flat display devices have been proposed in recent years in response to the ever increasing area of display images and the demand for flat display devices. Among these are plasma display devices incorporating a plasma display panel (for example, see FIG. 1 of Japanese Patent Kokai No. 2000-242229).

As illustrated in FIG. 1 a plasma display panel PDP 10 installed in such a plasma display device comprises a plurality of column electrodes D₁ to Dₘ (address electrodes), and a plurality of row electrodes X₁ to Xₙ and Y₁ to Yₙ arranged orthogonally to the column electrodes. Between the column electrodes D₁ to Dₘ, and the row electrodes X₁ to Xₙ and Y₁ to Yₙ are provided discharge spaces (not shown in the figures) in which is sealed a discharge gas. In this constitution, a discharge cell containing such a discharge space and corresponding to a pixel is formed at each intersection between a column electrode and a row electrode.

A driving device 100 applies driving pulses to the column electrodes and row electrodes of the PDP 10 to carry out gradation driving in the PDP 10 on the basis of a subfield method. In a subfield method, a unit display period (one field or one frame display period) is divided into N subfields having different brightness weighting, such that in each subfield each discharge cell is selectively made to emit light in accordance with an input video signal to display thereby half-tone brightness.

FIG. 2 is a diagram showing the application timing of various drive pulses applied by a drive control circuit of the driving device 100 to the PDP 10 within each subfield. In FIG. 2 is described the operation of 1 subfield among the N subfields.

First, in a simultaneous reset process Rc, the driving device 100 applies a positive reset pulse RP_{y} to each row electrode Y₁ to Yₙ while simultaneously applying a negative reset pulse RPₓ to the row electrodes X₁ to Xₙ, as shown in FIG. 2. In response to the application of these reset pulses RPₓ and RP_{y}, all the discharge cells of the PDP 10 perform reset discharge, whereby a predetermined wall charge is formed uniformly in each discharge cell.

In a pixel data write process Wc, the driving device 100, in accordance with an input video signal, generates pixel data pulses DP for indicating whether the discharge cells are to emit light or not, then the driving device 100 sequentially applies these pixel data pulses DP to the column electrodes D₁ to Dₘ, one display line at a time. Meanwhile, the driving device 100 applies sequentially scan pulses SP to the row electrodes Y₁ to Yₙ in synchronization with the application timing of the pixel data pulse DP. Discharge (selective erase discharge) occurs herein only in the discharge cells at the intersections between the display lines to which the scan pulse SP is applied and the column electrodes to which a high-voltage pixel data pulse DP is applied, whereby the wall charge remaining in these discharge cells is erased. On the other hand, the selective erase discharge described above does not take place in discharge cells to which are applied simultaneously a scan pulse SP and a low-voltage pixel data pulse, and therefore these discharge cells are held in the immediately preceding wall-charge formation state. That is, in the pixel data write process Wc the discharge cells are respectively set in either a light-emitting mode in which wall charge is formed, or in a light-extinction mode in which there is no wall charge, by selectively causing discharge in the discharge cells in accordance with the input video signal.

Next, in a light emission sustain process Ic, as shown in FIG. 2, the driving device 100 repeatedly applies a sustain pulse IPand IP_{y} to the row electrodes X₁ to Xₙ and Y₁ to Yₙ a number of times corresponding to the brightness weighting allotted to each subfield. Thereupon, only those discharge cells that are in the light emitting mode perform sustain discharge every time the sustain pulses IPₓ or IP_{y} are applied, to sustain thereby a discharge-induced light-emitting state.

Through the above-described driving in each subfield, the eye perceives a brightness corresponding to the aggregate sustain discharge count in each light emission sustain processes Ic for each unit display period.

In this context, plasma display devices have been proposed in which the brightness of the whole screen is controlled in accordance with APL (Average Picture Level) in order to display a bright whole screen within an limited permissible maximum consumption, and in order to increase the contrast ratio when displaying a dark image (for example, see Japanese Patent Kokai No. 2001-42820). When displaying bright images in such a plasma display device, the brightness level of the entire screen is reduced, and by extension power consumption is curbed, through a reduction of the sustain pulse application count allotted to each subfield. On the other hand, when displaying images having a low APL, i.e. dark images over the whole screen, the contrast ratio is increased by increasing the sustain pulse application count allotted to each subfield. Therefore, although the power consumption associated with sustain discharge is low when displaying dark images, ineffective sustain pulses are generated that do not contribute to light emission, which means that the power consumed in the generation of such sustain pulses is wasted.

### BRIEF DESCRIPTION OF THE DRAWINGS

FIG. 1 is a diagram illustrating the schematic constitution of a plasma display device.

FIG. 2 is a diagram illustrating the application timing of various driving pulses applied in the PDP 100 shown in FIG. 1.

FIG. 3 is a diagram illustrating the schematic constitution of a plasma display device for driving a plasma display panel in accordance with the driving method of the present invention.

FIG. 4 is a diagram illustrating the internal constitution of a Y power circuit 8 shown in FIG. 3.

FIG. 5 is a diagram illustrating the internal constitution of an X power circuit 9 shown in FIG. 3.

FIG. 6 is a diagram illustrating the application timing of various driving pulses applied in a PDP 10 shown in FIG. 3.

FIG. 7A and 7B are diagrams illustrating the modification operations of the pulse voltage and pulse count of sustain pulses in accordance with the driving method of the present invention.

FIG. 8 is a diagram illustrating the relationship between sustain pulse voltage and emission brightness level.

FIG. 9 is a diagram illustrating the relationship between brightness level and the total pulse count of sustain pulses (pulse voltage 170 volts) applied within a unit display period.

### SUMMARY OF THE INVENTION

In order to solve the above-described problems, it is an object of the present invention to provide a method for driving a plasma display panel that allows increasing contrast and curbing ineffectual power consumption.

The plasma display driving method according to one aspect of the present invention is a driving method being used for driving a plasma display panel in which a plurality of discharge cells corresponding each to a pixel are arranged in matrix form, comprising the steps of setting each discharge cell into either a light-emitting state or a light-extinction state on the basis of an input video signal; performing repeatedly sustain discharge in only said discharge cells set in said light-emitting mode, by repeated application of sustain pulses to respective said discharge cells; and changing a pulse voltage of said sustain pulses on the basis of an average brightness level per frame of said input video signal.

The pulse voltage of sustain pulses which are applied to discharge cells, supporting a pixel each, in order to cause discharge of the discharge cells and sustain a discharge-induced light-emission state, is modified on the basis of the average brightness level per frame of an input video signal.

### DESCRIPTION OF THE PREFERRED EMBODIMENTS

Embodiments of the present invention will be described in detail below with reference to the accompanying drawings.

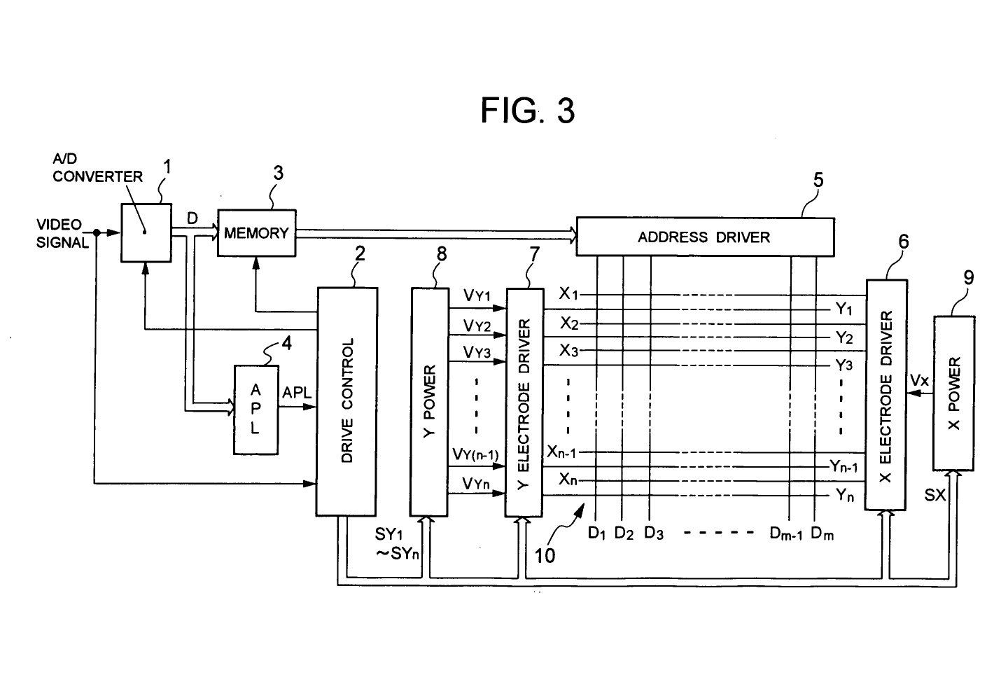

FIG. 3 is a diagram illustrating the schematic constitution of a plasma display device for light-emission driving of a plasma display panel (hereinafter, PDP) on the basis of the driving method according to the present invention.

In FIG. 3, column electrodes D₁ to Dₘ are arranged extending along the vertical direction (perpendicular direction) of a two-dimensional display screen of a PDP 10, as the plasma display panel, with row electrodes X₁ to Xₙ and Y₁ to Yₙ arranged extending in the longitudinal direction (horizontal direction) of the display screen. On the PDP 10, one display line corresponds to a mutually adjacent pair of row electrodes X and Y. Between the column electrodes D₁ to Dₘ, and the row electrodes X₁ to Xₙ and Y₁ to Yₙ are provided discharge spaces (not shown in the figures) in which is sealed a discharge gas; in this constitution, a discharge cell containing such a discharge space and corresponding to a pixel is formed at the intersection between a column electrode and a row electrode.

In response to a clock signal supplied by a drive control circuit 2, an A/D converter 1 samples an analog input video signal, converts the sampled input video signal into 8-bit pixel data D for each pixel, for example, and supplies the pixel data D to a memory 3 and an APL detecting circuit 4.

The memory 3 sequentially writes the pixel data D in response to a write signal supplied by the drive control circuit 2. In this write operation, when the writing for one screen (n rows, m columns) is complete, the memory 3 reads the pixel data D of one screen and successively supplies this pixel data to an address driver 5, one row at a time.

The APL detecting circuit 4, on the basis of the pixel data D, determines the average brightness level one image frame at a time and supplies an average brightness level signal APL, indicating the average brightness level, to the drive control circuit 2.

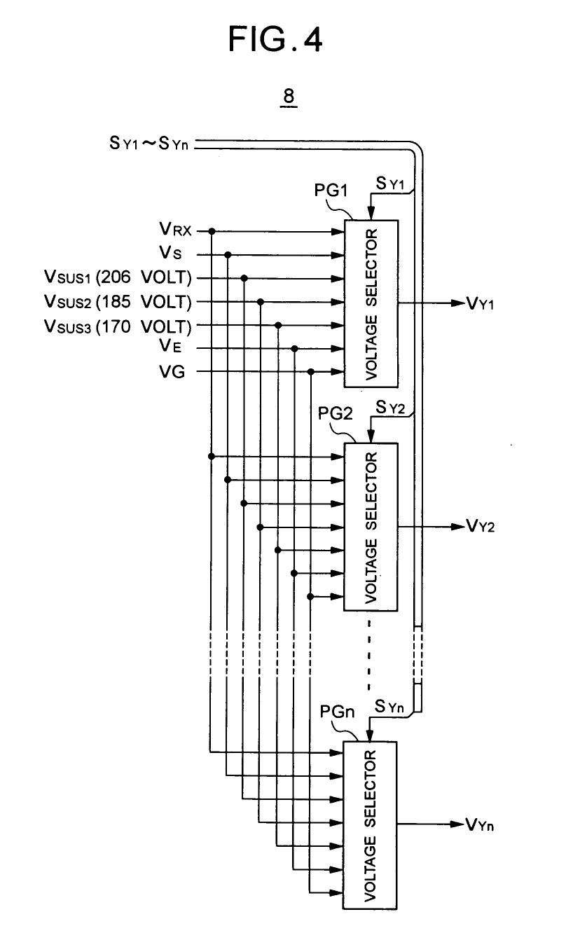

As illustrated in FIG. 4, a Y power circuit 8 comprises voltage selectors PG₁ to PGₙ corresponding to the n row electrodes Y₁ to Yₙ. Each voltage selector PG selects, from among various DC voltages described below, the voltage indicated by a pulse voltage selection signal SY, and supplies that voltage, as a pulse voltage Vy, to a Y electrode driver 7. Specifically, for instance, a power selector PG₁ selects from among V_{RY}, V_{S}, V_{SUS1} to V_{SUS3}, V_{E}, or V_{G} described below, the voltage indicated by a voltage selection signal SY₁, and outputs that voltage, as a pulse voltage V_{Y1}, to the Y electrode driver 7. Similarly, a power selector PG2 selects from among V_{RY}, V_{S}, V_{SUS1} to V_{SUS3}, V_{E}, or VG described below, the voltage indicated by a voltage selection signal S_{Y2}, and outputs that voltage, as a pulse voltage V_{Y2}, to the Y electrode driver 7, while a power selector PGₙ selects from among V_{RY}, V_{S}, V_{SUS1} to VSUS₃, V_{E}, or V_{G} described below, the voltage indicated by a voltage selection signal SYₙ, and outputs that voltage, as a pulse voltage V_{Yn}, to the Y electrode driver 7.

V_{RY}: reset pulse voltage

V_{S}: scan pulse voltage

V_{SUS1} to VSUS₃: sustain pulse voltage

V_{E}: erase pulse voltage

VG: reference voltage

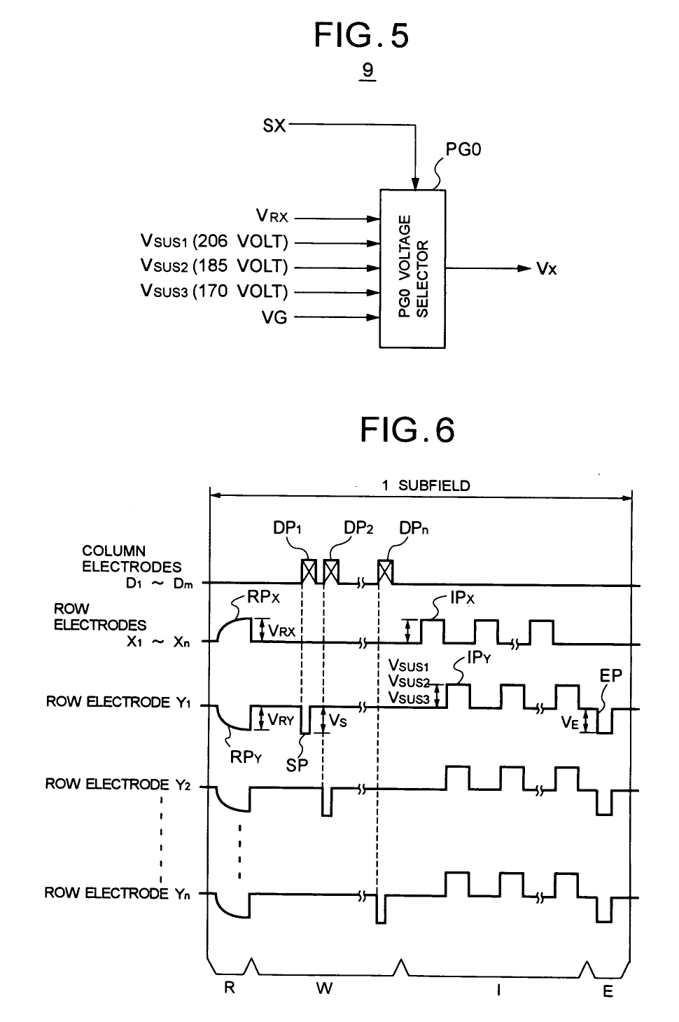

As illustrated in FIG. 5, an X power circuit 9 comprises a single voltage selector PGO, which selects, from among various DC voltages described below, the voltage indicated by a pulse voltage selection signal SX, and supplies that voltage, as a pulse voltage V_{X}, to an X electrode driver 6.

V_{RX}: reset pulse voltage

V_{SUS1} to VSUS₃: sustain pulse voltage, wherein V_{SUS1}<V_{SUS2}<V_{SUS3}

The drive control circuit 2, in synchrony with a horizontal and a vertical synchronizing signal of the input video signal, generates a clock signal that is supplied to the A/D converter 1 and a write and read signal that is supplied to the memory 3. On the basis of the pixel data read from the memory 3, the drive control circuit 2 generates pixel driving data for designating whether each discharge cell is to emit light or not, supplies this pixel driving data to the address driver 5, generates various timing signals for gradation driving of the PDP 10 in accordance with the subfield method, and supplies the respective timing signals to the X electrode driver 6 and the Y electrode driver 7. The drive control circuit 2 supplies to an X voltage selector 9 a pulse voltage selection signal SX for selecting the various driving pulses (explained below) that are applied to the row electrodes X₁ to Xₙ. The drive control circuit 2 also supplies to Y voltage selectors 8₁ to 8ₙ respective pulse voltage selection signals SY₁ to SYₙ for separately selecting the various driving pulses (explained below) that are applied to the row electrodes Y₁ to Yₙ.

The address driver 5, the X electrode driver 6 and the Y electrode driver 7, in accordance with the timing signals supplied by the drive control circuit 2, generate within each subfield various drive pulses, as illustrated in FIG. 4, and apply these pulses to the column electrodes D₁ to Dₘ and the row electrodes X₁ to Xₙ and Y₁ to Yₙ of the PDP 10.

With reference to FIG. 4, during the reset process R, the drive control circuit 2 supplies to the X power circuit 9 a pulse voltage selection signal SX for selecting a reset pulse voltage V_{RX} and supplies to the Y power circuit 8 pulse voltage selection signals SY₁ to SYₙ for selecting a reset pulse voltage V_{RY}. Thereby, the X electrode driver 6 generates a positive reset pulse RP_{X} having a gradual voltage transition upon pulse rise and having a peak voltage V_{RX}, as illustrated in FIG. 6, and applies this positive reset pulse RP_{X} to each of the row electrodes X₁ to Xₙ. Also, the Y electrode driver 7 generates a negative reset pulse RP_{X} having a gradual voltage transition upon pulse rise and having a peak voltage V_{RY}, as illustrated in FIG. 6, and applies this negative reset pulse RP_{Y} to each of the row electrodes Y₁ to Yₙ. In response to the application of these reset pulses RP_{X} and RP_{Y} all the discharge cells in the PDP 10 undergo reset discharge, whereby a predetermined wall charge is formed uniformly in each discharge cell.

In the address process W, the drive control circuit 2 supplies to the Y power circuit 8 pulse voltage selection signals SY₁ to SYₙ for selecting a scan pulse voltage V_{S}. Thereby, the Y electrode driver 7 generates a negative scanning pulse SP with a pulse voltage V_{S}, and applies this negative scanning pulse SP to the row electrodes Y₁ to Yₙ in succession, as illustrated in FIG. 6. At the same time, the address driver 5 generates a pixel data pulse DP having a pulse voltage corresponding to the logic level indicated by the pixel driving data supplied by the drive control circuit 2, and successively applies this pixel data pulse DP to the column electrodes D₁ to Dₘ, one display line at a time. Discharge (selective erase discharge) occurs herein only in the discharge cells at the intersections between the display lines to which the scan pulse SP is applied and the column electrodes to which a high-voltage pixel data pulse is applied, whereby the wall charge remaining in these discharge cells is erased. On the other hand, the selective erase discharge described above does not take place in discharge cells to which are applied simultaneously the scan pulse SP and a low-voltage pixel data pulse, and therefore these discharge cells are held in the immediately preceding wall-charge formation state. That is, in the address process W, by selectively causing discharge in the discharge cells in accordance with the pixel data, the discharge cells are respectively set in either the light-emitting mode in which wall charge is formed, or in the light extinction mode in which there is no wall charge.

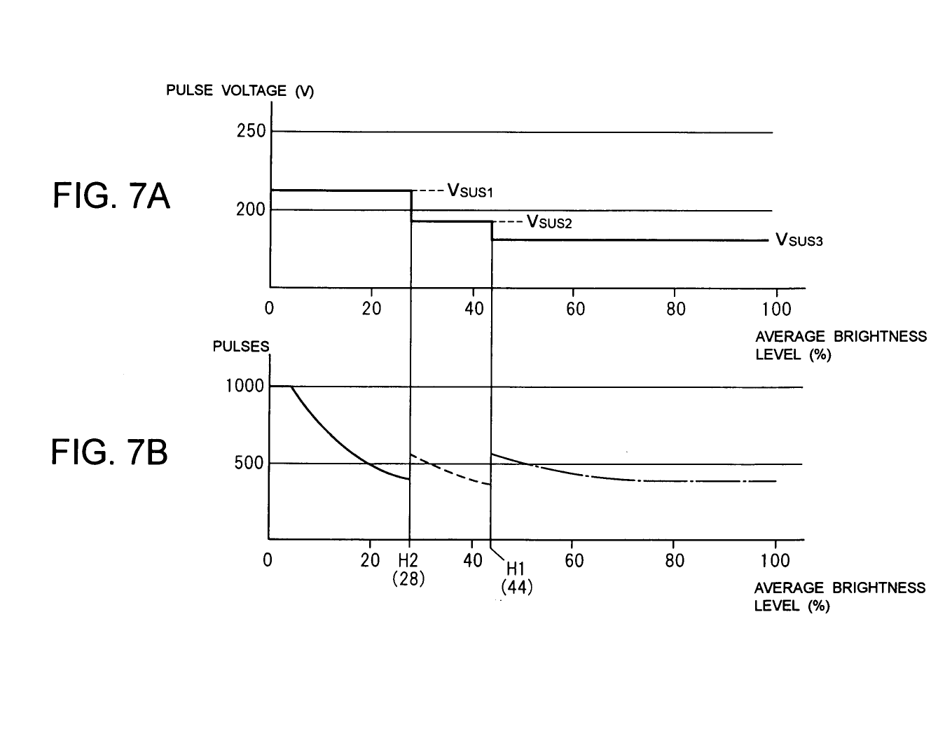

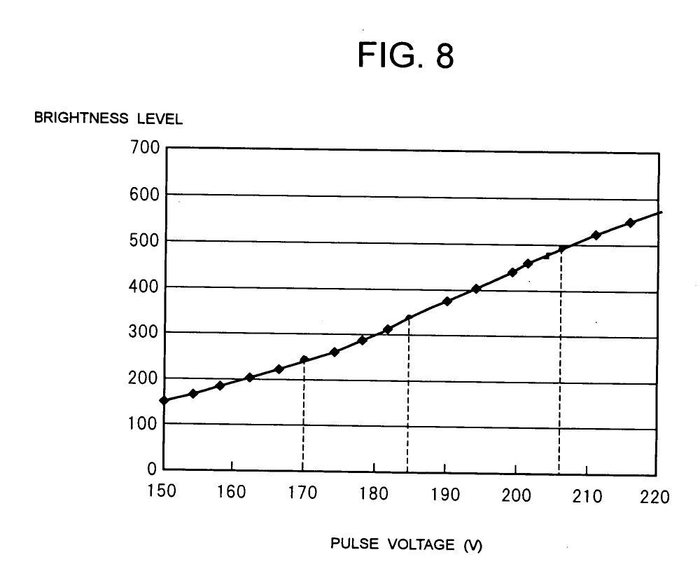

Next, in a sustain process I, when the average brightness level per image frame, as indicated by the average brightness level signal APL, is higher than a predetermined first level H1 as illustrated in FIGS. 7A, 7B, the drive control circuit 2 supplies respectively to the Y power circuit 8 and the X power circuit 9 pulse voltage selection signals SY and SX for selecting V_{SUS3} as the sustain pulse voltage. When the average brightness level is lower than the first level H1 but higher than a second level H2, as illustrated in FIGS. 7A, 7B, the drive control circuit 2 supplies respectively to the Y power circuit 8 and the X power circuit 9 pulse voltage selection signals SY and SX for selecting V_{SUS2} larger than V_{SUS3}, as the sustain pulse voltage. When the average brightness level is lower than the second level H2, as illustrated in FIGS. 7A, 7B, the drive control circuit 2 supplies respectively to the Y power circuit 8 and the X power circuit 9 pulse voltage selection signals SY and SX for selecting V_{SUS1}, larger than V_{SUS2}, as the sustain pulse voltage. As a result, the X electrode driver 6 and the Y electrode driver 7 generate respectively positive sustain pulses IP_{X} and IP_{Y} having a sustain voltage of V_{SUS1}, V_{SUS2}, or V_{SUS3}, and repeatedly apply these positive sustain pulses to the row electrodes X₁ to Xₙ and Y₁ to Yₙ a number of times corresponding to the brightness weighting allotted to each subfield. The drive control circuit 2 sets herein the total sustain pulse count IP_{X} and IP_{Y} to be applied within a unit display period in accordance with the average brightness level signal APL and the sustain pulse voltage V_{SUS}. The X electrode driver 6 and the Y electrode driver 7 determine thus, on the basis of the total sustain pulse count set by the drive control circuit 2, the respective pulse count with which sustain pulses are applied during the sustain process I in each subfield.

By executing the above sustain process I, thus, only discharge cells set to the light-emitting mode perform sustain discharge every time the sustain pulses IP_{X} or IP_{Y} are applied, to sustain thereby a discharge-induced light-emitting state. The resulting perceived brightness corresponds to the aggregate number of times that sustain discharge occurs within each unit display period.

Next, in the erase process E, the drive control circuit 2 supplies to the Y power circuit 8 pulse voltage selection signals SY₁ to SYₙ for selecting an erase pulse voltage V_{E}. As a result, the Y electrode driver 7 generates a negative erase pulse EP having a pulse voltage VE, as shown in FIG. 6, and applies this erase pulse EP to the row electrodes Y₁ to Yₙ. In response to the application of such erase pulse EP, the wall charges formed in the discharge cells through sustain discharge during the sustain process I are erased.

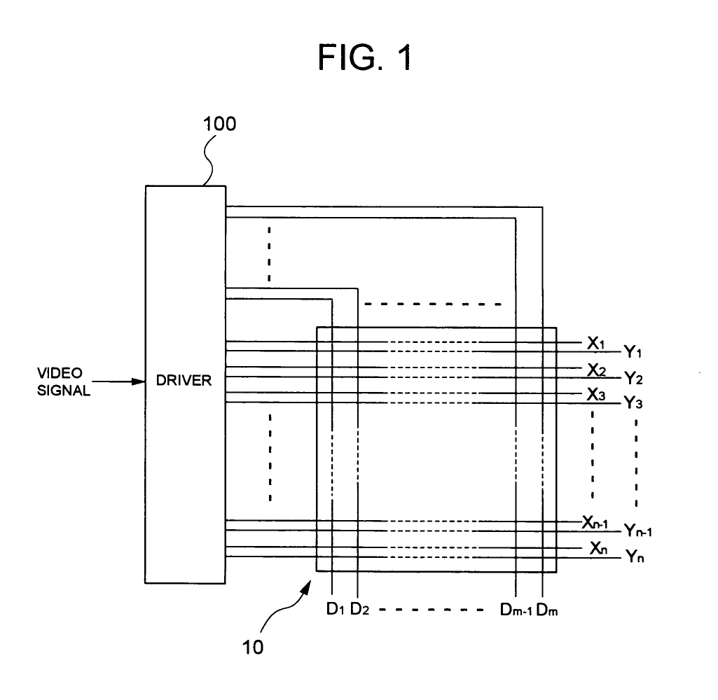

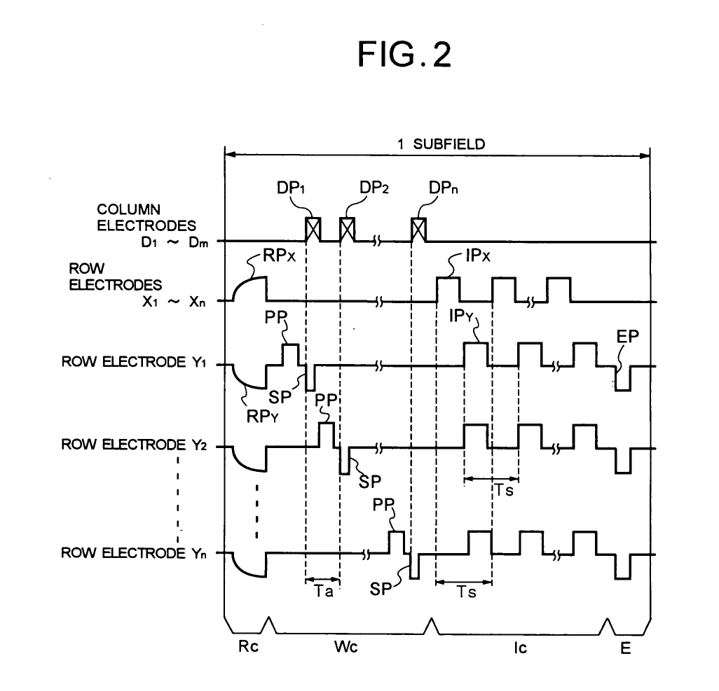

The detailed application operation of the sustain pulses IP_{X} and IP_{Y} in the plasma display device of FIG. 1 is explained next.

First, when the average brightness level per image frame (or per subfield) is higher than the first level H1 (44% of the maximum brightness level), sustain pulses IP_{X} and IP_{Y} having a pulse voltage V_{SUS3} (170 volt) as shown in FIG. 7A are applied to the row electrodes X₁ to Xₙ and Y₁ to Yₙ. The total number of pulses IP_{X} and IP_{Y} corresponding to the average brightness level and to be applied within a unit display period is herein the count represented by the dot-dash line in FIG. 7B.

When the average brightness level is lower than the first level H1 and higher than he second level H2 (28% of the maximum brightness level), sustain pulses IP_{X} and IP_{Y} having a pulse voltage V_{SUS2} (185 volt) as shown in FIG. 7A are applied to the row electrodes X₁ to Xₙ and Y₁ to Yₙ. The total number of pulses IP_{X} and IP_{Y} corresponding to the average brightness level and to be applied within a unit display period is herein the count represented by the wavy line in FIG. 7B.

When the average brightness level is lower than the second level H2, sustain pulses IP_{X} and IP_{Y} having a pulse voltage V_{SUS1} (206 volt) as shown in FIG. 7A are applied to the row electrodes X₁ to Xₙ and Y₁ to Yₙ. The total number of pulses IP_{X} and IP_{Y} corresponding to the average brightness level and to be applied within a unit display period is herein the count represented by the solid line in FIG. 7B.

In the plasma display device illustrate din FIG. 1, thus, a lower average brightness level per image frame (or per subfield) entails a higher pulse voltage of the sustain pulses IP_{X} and IP_{Y}. Herein, the higher the pulse voltage of the sustain pulses IP_{X} and IP_{Y}, the higher the brightness level upon light emission as a result of sustain discharge by the application of the sustain pulses as shown in FIG. 8.

That is, dark room contrast is increased when displaying a dark image over the entire screen by switching to a higher pulse voltage of the sustain pulses, thereby increasing the emission brightness level per sustain discharge. When displaying a dark image over the whole screen, therefore, the application of the sustain pulses reduces ineffectual power consumption as compared with increasing the sustain pulse application frequency allotted to each subfield.

Herein, an abrupt brightness change occurs upon switching the pulse voltage of sustain pulses to a high voltage as described above.

For instance, as shown in FIG. 8, the emission brightness level associated with the sustain discharge resulting from the application of sustain pulses having a sustain voltage V_{SUS1} of 206 volts is about 2^{(1/2)} times the emission brightness level associated with the sustain discharge resulting from the application of sustain pulses having a sustain voltage V_{SUS2} of 185 volts. Similarly, the emission brightness level associated with the sustain discharge resulting from the application of sustain pulses having a sustain voltage V_{SUS2} of 185 volts is about 2^{(1/2)} times the emission brightness level associated with the sustain discharge resulting from the application of sustain pulses having a sustain voltage V_{SUS3} of 170 volts.

In order to control such brightness changes, therefore, the total sustain pulse count applied within a unit display period is adjusted taking as a reference the total sustain pulse count applied within a unit display period upon application of sustain pulses having a sustain voltage of 170 volt. Herein the brightness weighting value allotted to each subfield remains unchanged.

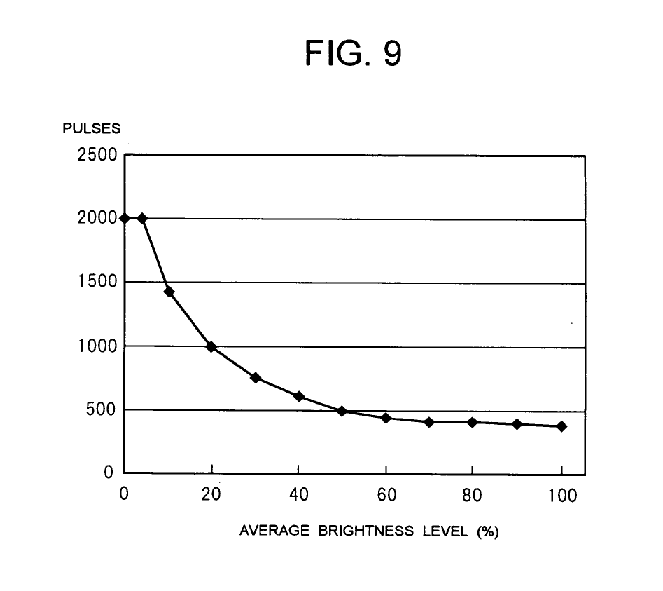

FIG. 9 illustrates the relationship between the application frequency of sustain pulses having a sustain voltage V_{SUS3} of 170 volts and the resulting brightness level visually perceived.

When the first brightness level H1 is displayed, i.e. when a brightness level equivalent to 44% of the maximum brightness level is displayed, applying sustain pulses having a pulse voltage V_{SUS3} of 170 volts results in the sustain pulses being applied 566 times in a unit display period, as illustrated in FIG. 9. The brightness level decreases then 2^{(1/2)} times when the pulse voltage of the sustain pulses is switched from 170 volt (VSUS₃) to 185 volt (VSUS₂) . Thus, as illustrated in FIG. 7B, the total sustain pulse count changes by ½^{(1/2)} , i.e. to [566 times/ 2^{(1/2)}]=400 times. It becomes possible thereby to display a brightness level of 44% of the maximum brightness level also when switching the pulse voltage of the sustain pulse from 170 volt (VSUS₃) to 185 volt (VSUS₂), as illustrated in FIG. 7A.

When the brightness level of the second level H2 is displayed, i.e. when a brightness level equivalent to 28% of the maximum brightness level is displayed, sustain pulses having a pulse voltage V_{SUS3} of 170 volts are applied 800 times in a unit display period, as illustrated in FIG. 9. When the pulse voltage of the sustain pulses is switched to 206 volt (V_{SUS1}), the brightness level visually perceived becomes twice the brightness level perceived when 170-volt sustain pulses are applied. Thus, as illustrated in FIG. 7B, the total sustain pulse count changes to ½times the count in FIG. 9, i.e. to [800 times/2]=400 times. It becomes possible thereby to display a brightness level of 44% of the maximum brightness level also when switching the pulse voltage of the sustain pulse from 185 volt (V_{SUS2}) to 206 volt (V_{SUS1}), as illustrated in FIG. 7A.

That is, when displaying a brightness level ranging from 44% of the maximum brightness level to the maximum brightness level sustain pulses having a pulse voltage V_{SUS1} of 170 volts are applied the number of times indicated in FIG. 9 (dot dash line in FIG. 7B). When displaying a brightness level ranging from 28% of the maximum brightness level to 44% of the maximum brightness level sustain pulses having a pulse voltage VSUS₂of 185 volts are applied ½hu (1/2) the number of times indicated in FIG. 9 (wavy line in FIG. 7B). Finally, when displaying a brightness level ranging from 4% of the maximum brightness level to 28% of the maximum brightness level sustain pulses having a pulse voltage V_{SUS1} of 206 volts are applied ½the number of times indicated in FIG. 9 (solid line in FIG. 7B). Thus, abrupt brightness level changes can be curbed when switching pulse voltages of sustain pulses, such as those illustrated in FIG. 7A by adjusting the total sustain pulse count of the application frequency within a unit display period (one frame or one field display period).

In the above embodiments the pulse voltage of the sustain pulses is switched in three steps V_{SUS1} to V_{SUS3} in accordance with the average brightness level per image frame; however, this switching is not limited to three steps. In essence, all that is needed herein is to use, as the pulse voltage of the sustain pulses, one pulse voltage among mutually differing k (an integer equal to 2 or higher) pulse voltages in accordance with the average brightness level per image frame. In terms of brightness variation rate upon pulse voltage switching, abrupt brightness level changes can be curbed, as illustrated in FIG. 7B, by multiplying the inverse of the variation rate by the reference total sustain pulse count to be applied in a unit display period and by adjusting then the total pulse count.

In FIG. 7B, when the average brightness level per image frame is 0 to 4% of the maximum brightness level, the total sustain pulse count becomes 1000, taking as a reference the case wherein the total sustain pulse count (pulse voltage=170 volt) applied in a unit display period is 2000 pulses, as in FIG. 9. However, it is also possible to use a pulse count smaller than 2000, as the total sustain pulse count (pulse voltage=170 volt) applied in a unit display period, by increasing the pulse voltage so as to offset the brightness drop associated with the smaller pulse count. When the average brightness level per image frame is 0 to 4% of the maximum brightness level, moreover, the total sustain pulse count (pulse voltage=206 volt) to be applied in a unit display period can be smaller than 1000 pulses. In this case the 206 pulse voltage is further increased so as to offset the brightness drop associated with the smaller pulse count.

This application is based on Japanese Patent Application No. 2005-100784 which is hereby incorporated by reference.

What is claimed is:

1. A plasma display driving method for driving a plasma display panel in which a plurality of discharge cells corresponding each to a pixel are arranged in matrix form, comprising the steps of:
setting each discharge cell into either a light-emitting state or a light-extinction state on the basis of an input video signal;
performing repeatedly sustain discharge in only said discharge cells set in said light-emitting mode, by repeated application of sustain pulses to respective said discharge cells; and
changing a pulse voltage of said sustain pulses on the basis of an average brightness level per frame of said input video signal.

2. A plasma display driving method according to claim 1, wherein in said pulse voltage changing step, when said average brightness level is low, the pulse voltage of said sustain pulses is set to a higher voltage than when said average brightness level is high.

3. A plasma display driving method according to claim 1, wherein in said pulse voltage changing step, when said average brightness level is higher than a predetermined first level, the pulse voltage of said sustain pulses is set to a predetermined first voltage value, and when said average brightness level is lower than said first level, the pulse voltage of said sustain pulses is set to a predetermined second voltage value which is higher than said first voltage value.

4. A plasma display driving method according to claim 2, wherein in said pulse voltage changing step, when said average brightness level is higher than a predetermined first level, the pulse voltage of said sustain pulses is set to a predetermined first voltage value, and when said average brightness level is lower than said first level, the pulse voltage of said sustain pulses is set to a predetermined second voltage value which is higher than said first voltage value.

5. A plasma display driving method according to claim 1, further comprising the step of changing a total pulse count of said sustain pulses applied per unit display period on the basis of said pulse voltage.

6. A plasma display driving method according to claim 1, further comprising the step of, when said average brightness level is lower than a predetermined first level, decreasing the total pulse count of said sustain pulses applied per unit display period than when said average brightness level is higher than said first level, wherein
in said pulse voltage changing step, when said average brightness level is lower than said first level, said pulse voltage is set to a higher voltage than when said average brightness level is higher than said first level.
